(19) United States
(12) Patent Application Publication
(10) Pub. No.: US 2008/0070510 A1
(43) Pub. Date: Mar. 20, 2008

(54) INTERFERENCE MANAGEMENT TECHNIQUES FOR WIRELESS NETWORKS

(75) Inventors: Klaus Doppler, Espoo (FI); He Xiaoben, Espoo (FI); Carl Simon Wijting, Helsinki (FI); Antti Sorri, Helsinki (FI)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation, Espoo (FI)

(21) Appl. No.: 11/854,985

(22) Filed: Sep. 13, 2007

Related U.S. Application Data
(60) Provisional application No. 60/826,085, filed on Sep. 18, 2006.

(51) Int. Cl. H04B 7/00

(52) U.S. Cl. 455/69

(57) ABSTRACT

Various embodiments are disclosed relating to techniques for managing interference among nodes in a wireless network. According to an example embodiment, a first measurement of a first interference activity may be determined at a first wireless node in a wireless network. A determination may be made that the first interference activity is unacceptable based on the first measurement. A first interference report including an indication of the unacceptable first interference activity may be sent to a second wireless node for transmission to a base station for processing by the base station. According to an example embodiment, an interference report including an indication of an unacceptable first interference activity for a first wireless node in a wireless network may be received. At least one adaptation parameter value may be determined based on the interference report. An adaptation message including the at least one adaptation parameter may be transmitted.

### CROSS-REFERENCE TO RELATED APPLICATION

This application claims priority to U.S. Provisional Application Ser. No. 60/826,085, filed on Sep. 18, 2006, entitled “Interference Management Techniques for Wireless Networks,” hereby incorporated by reference.

### BACKGROUND

Wireless networks, such as 3GPP LTE (3rd Generation Partnership Project Long Term Evolution), IEEE802.16, and wireless local area networks (WLAN) typically communicate via radio or other frequencies. In a WLAN, for example, mobile stations are typically moving around, and may communicate with an access point (AP) or base station. The AP is typically a fixed device that may (or may not) be connected to infrastructure networks or wired networks.

The most common WLAN technology is described in the Institute of Electrical and Electronics Engineers IEEE 802.11 family of industry specifications, such as specifications for IEEE 802.11b, IEEE 802.11g and IEEE 802.11a. Other wireless networks are based on cellular technologies, such as Global System For Mobile Communications (GSM), for example. Some networks are being developed based on other standards or technologies, such as IEEE 802.16 type systems and WiMedia ultra-wideband (UWB) common radio platform to augment the convergence platform with TCP/IP services. Networks are also being developed based on 3GPP LTE technology to develop a framework for the evolution of the 3GPP radio-access technology towards a high-data-rate, low-latency and packet-optimized radio-access technology. Example objectives of 3GPP LTE may include a focus on demand for higher data rates, expectations of additional 3G spectrum allocations, and greater flexibility in frequency allocations. A number of working groups are working to improve on these various technologies. These are merely a few examples of wireless networks, and a number of other wireless networks and technologies exist or are being developed.

In transmission of signals, inter-symbol interference may occur when the reciprocal of the system rate is significantly shorter than the time dispersion of a channel. This problem may become increasingly important when applying higher data rates (e.g., larger bandwidths). One way to address this problem includes an implementation of multi carrier systems, wherein the used bandwidth is divided into subcarriers that are sufficiently narrow so that the characteristics of the subcarriers are almost ideal for the offered data rate (i.e., no equalizer may be needed).

Recently several multi carrier schemes have been developed, such as, for example, Orthogonal Frequency Division Multiplexing (OFDM), Orthogonal Frequency Division Multiple Access (OFDMA), and Multi Carrier Code Division Multiple Access (MC-CDMA).

When OFDM is used, orthogonal subcarriers may be created by means of a Fourier transformation. OFDM as such may not provide any multiple access capability, as all subcarriers may be used simultaneously. Thus, OFDM may be used in combination with example multiple access schemes such as Time Division Multiple Access (TDMA), Frequency Division Multiple Access (FDMA), or Carrier Sense Multiple Access (CSMA) to provide multiple access capability.

The subcarriers may also be assigned individually or in groups (e.g., channels) to different users, in which case the scheme may be referred to as OFDMA (OFDM Access).

Examples of current systems, or systems currently under development may include IEEE 802.11a which may include use of OFDM, IEEE 802.16 (Wimax) which may include use of OFDMA, and 3GPP Long Term Evolution (LTE) which may include use of OFDMA in downlink.

As a further example, many different air interfaces (e.g., OFDMA, etc.) are being considered as part of an example WINNER project. For example, a WINNER radio interface may include a packet-oriented, user-centric, always-best concept. WINNER may provide a scalable and flexible radio interface based on adaptive and compatible system modes tailored to particular situations such as the radio environment, the usage scenario, the economic model, etc. The always-best solution may be enabled by example components, such as:
1) a flexible multi-mode protocol architecture enabling efficient interworking between different system modes, which are able to adapt to various deployment scenarios such as wide area, metropolitan area and local area,
2) relay-enhanced cells,
3) design and support for operation in shared spectrum and inter-system coordination,
4) example medium access layer (MAC) design for packet-oriented transmission including two-layered resource scheduling and short radio interface delays,
5) resource allocation targeting interference avoidance by coordinated scheduling across base stations and relay nodes or using joint (spatial) precoding over distributed antennas,
6) physical layer design using generalized multi-carrier (GMC) in different configurations to allow low complexity, high spectral efficiency, and high granularity of resource elements,
7) a spatial multi-user link adaptation concept allowing scalability in link adaptation and multi-user optimization and being able to adapt to a wide range of deployments, operational scenarios, propagation channel, service requirements, and terminal capabilities,
8) multi-user precoding techniques developed within WINNER,
9) support of self-organized synchronization of terminals and base station, and
10) optimization techniques for overhead and control signaling.

Interference avoidance schemes for multi-hop ad-hoc networks have been studied, e.g., forming clusters of wireless nodes and allowing only clusters that do not interfere to transmit concurrently. However, a solution for intra-cell interference coordination in a relay enhanced cell of a cellular network may be desirable.

### SUMMARY

Various embodiments are disclosed relating to techniques for managing interference among nodes in a wireless network.

According to an example embodiment, a first measurement of a first interference activity may be determined at a first wireless node in a wireless network. A determination may be made that the first interference activity is unacceptable based on the first measurement. A first interference report including an indication of the unacceptable first interference activity may be sent to a second wireless node for transmission to a base station for processing by the base station.

According to another example embodiment, an interference report including an indication of an unacceptable first interference activity for a first wireless node in a wireless network may be received. At least one adaptation parameter value may be determined based on the interference report. An adaptation message including the at least one adaptation parameter may be transmitted.

In another example embodiment, an apparatus may be provided that includes a controller, a memory coupled to the controller, and a wireless transceiver coupled to the controller. The apparatus may be adapted to: determine a first measurement of a first interference activity at the apparatus, make a determination that the first interference activity is unacceptable based on the first measurement, and send a first interference report including an indication of the unacceptable first interference activity to another apparatus for transmission to a base station for processing by the base station.

In another example embodiment, an apparatus may be provided that includes a controller, a memory coupled to the controller, and a wireless transceiver coupled to the controller. The apparatus may be adapted to: receive an interference report including an indication of an unacceptable first interference activity for a first wireless node, determine at least one adaptation parameter value based on the interference report, and transmit an adaptation message including the at least one adaptation parameter.

### BRIEF DESCRIPTION OF THE DRAWINGS

FIG. 1 is a block diagram illustrating a wireless network according to an example embodiment.

FIG. 2 is a block diagram illustrating a wireless network according to an example embodiment.

FIG. 3a is a block diagram illustrating a wireless relay network according to an example embodiment.

FIG. 3b is a diagram of a multi-hop environment according to an example embodiment.

FIG. 4 is a diagram illustrating an example difference between hard and soft frequency reuse according to an example embodiment.

FIGS. 5a-5b are diagrams illustrating example frame structures for transmission of information according to an example embodiment.

FIG. 6 illustrates an example wireless relay network according to an example embodiment.

FIG. 7 illustrates an example wireless relay network according to an example embodiment.

FIG. 8 is a diagram illustrating example power masks according to an example embodiment.

FIG. 9 is a diagram illustrating an example flow of messages according to an example embodiment.

FIG. 10a is a diagram illustrating an example interference report element format according to an example embodiment.

FIG. 10b is a diagram illustrating an example interference element format according to an example embodiment.

FIG. 10c is a diagram illustrating an example forwarded interference report format according to an example embodiment.

FIG. 11 is a flow chart illustrating operation of a wireless node according to an example embodiment.

FIG. 12 is a flow chart illustrating operation of a wireless node according to an example embodiment.

FIG. 13 is a block diagram illustrating an apparatus that may be provided in a wireless node according to an example embodiment.

### DETAILED DESCRIPTION

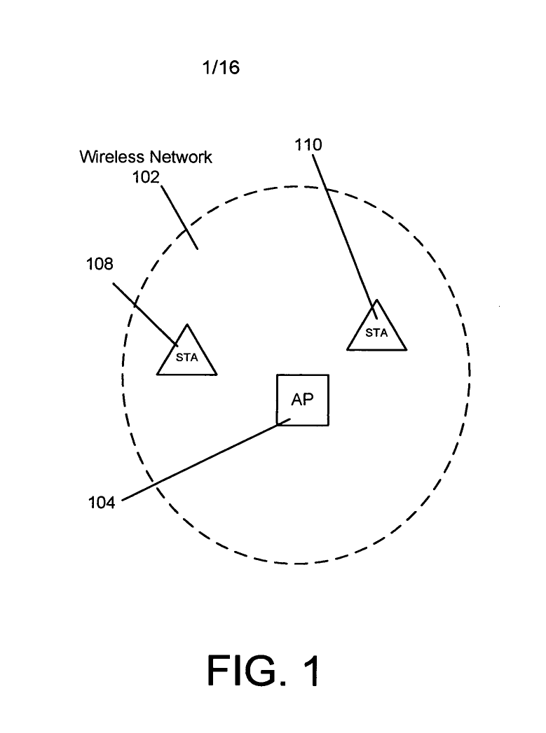

Referring to the Figures in which like numerals indicate like elements, FIG. 1 is a block diagram illustrating a wireless network 102 according to an example embodiment. Wireless network 102 may include a number of wireless nodes or stations, such as an access point (AP) 104 or base station and one or more mobile stations or subscriber stations, such as stations 108 and 110. While only one AP and two mobile stations are shown in wireless network 102, any number of APs and stations may be provided. Each station in network 102 (e.g., stations 108, 110) may be in wireless communication with the AP 104, and may even be in direct communication with each other. Although not shown, AP 104 may be coupled to a fixed network, such as a Local Area Network (LAN), Wide Area Network (WAN), the Internet, etc., and may also be coupled to other wireless networks.

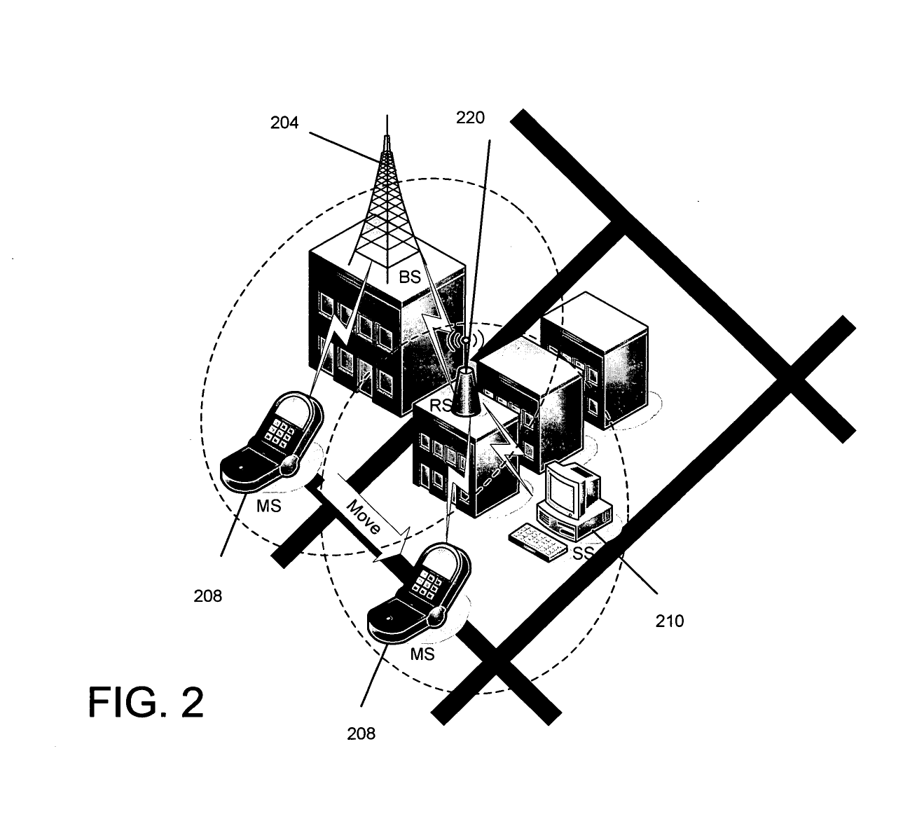

FIG. 2 is a block diagram illustrating a wireless network according to an example embodiment. According to an example embodiment, a mobile station MS 208 may initially communicate directly with a base station BS 204, for example, and a subscriber station 210 may communicate with the base station BS 204 via a relay station RS 220. In an example embodiment, the mobile station 208 may travel or move with respect to base station BS 204. For example, the mobile station MS 208 may move out of range of the base station BS 204, and may thus begin communicating with the base station 204 via the relay station 220 as shown in FIG. 2.

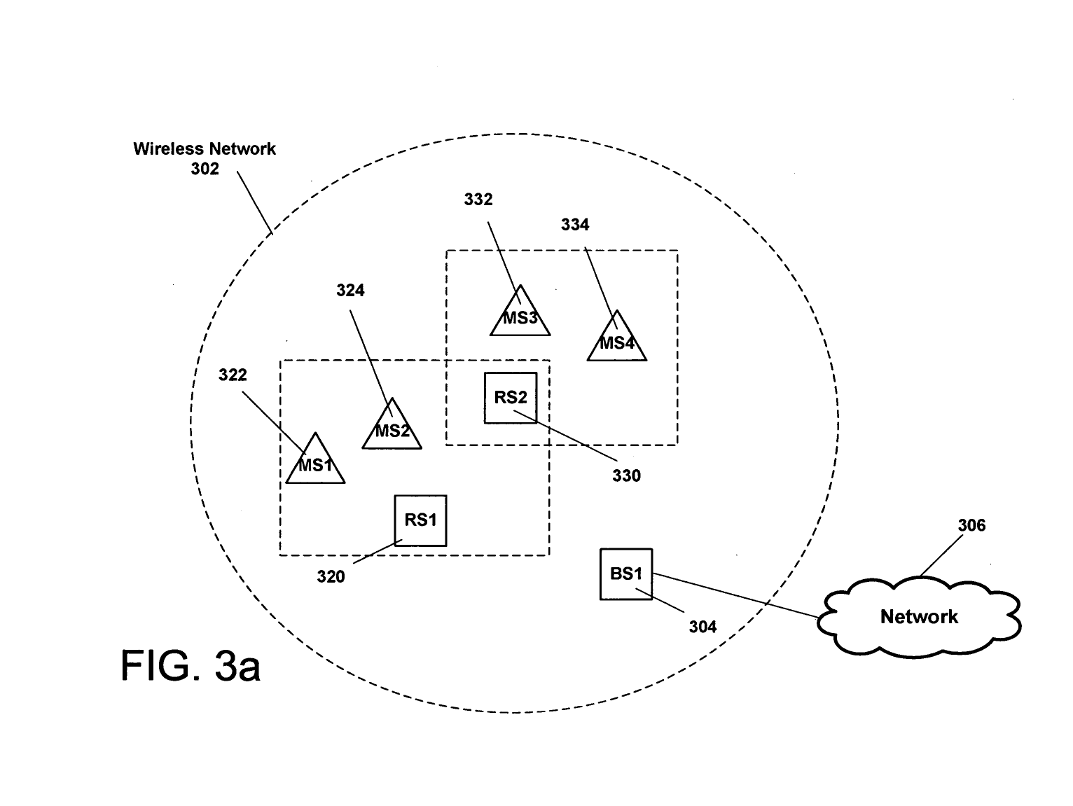

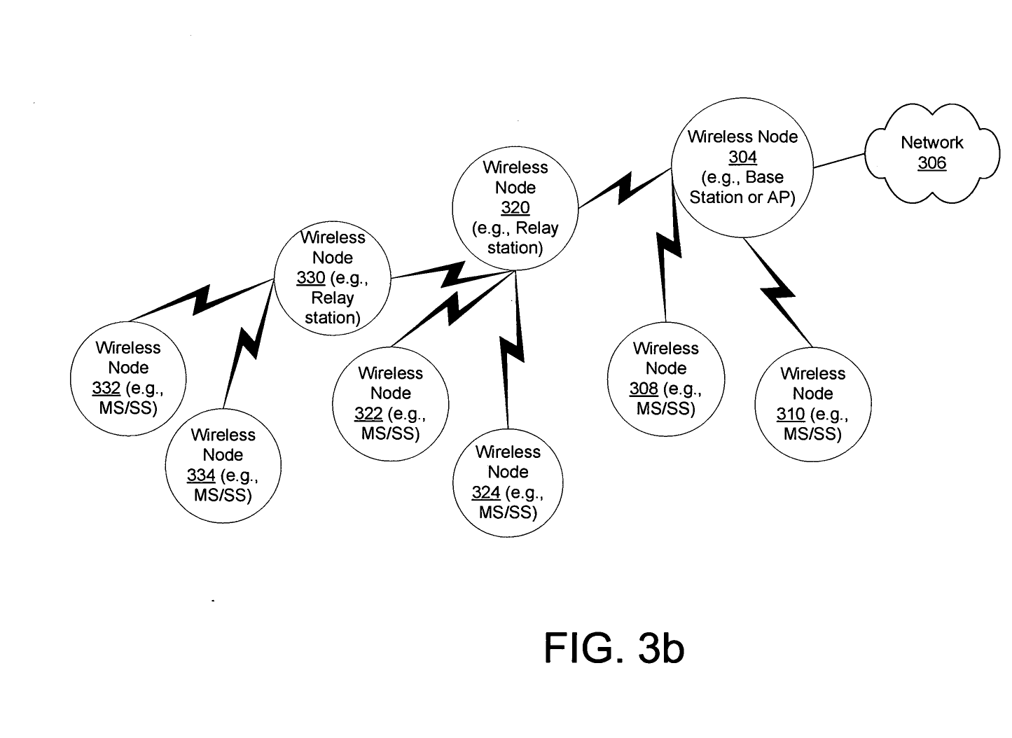

FIG. 3a is a block diagram illustrating a wireless network 302 according to an example embodiment. Wireless network 302 may include a number of wireless nodes or stations, such as base station BS1 304, relay stations RS1 320 and RS2 330, a group of mobile stations, such as MS1 322 and MS2 324 communicating with relay station RS1 320, and MS3 332 and MS4 334 communicating with relay station RS2 330. As shown, relay station RS2 330 also communicates with relay station RS1 320. While only one base station, two relay stations, and four mobile stations are shown in wireless network 302, any number of base stations, relay stations, and mobile stations may be provided. The base station 304 may be coupled to a fixed network 306, such as a Wide Area Network (WAN), the Internet, etc., and may also be coupled to other wireless networks. The group of stations MS1 322, MS2 324, and RS2 330 may communicate with the base station BS1 304 via the relay station RS1 320. The group of stations MS3 332, MS4 334, may communicate with the base station BS1 304 via the relay station RS2 330, which communicates with the base station BS1 304 via the relay station RS1 320.

FIG. 3b is a diagram of a multi-hop environment according to an example embodiment. A group of wireless nodes 332, 334, which may be mobile stations or subscriber stations (MS/SS) may each be coupled via a wireless link to a wireless node 330. As an example, the wireless nodes 332, 334 may include mobile telephones, wireless digital assistants (PDAs), or other types of wireless access devices, or mobile stations. The term “node” or “wireless node” or “network node” or “network station” may refer, for example, to a wireless station, e.g., a subscriber station or mobile station, an access point or base station, a relay station or other intermediate wireless node, or other wireless computing device, as examples. Wireless node 330 may include, for example, a relay station or other node. Wireless node 330 and other wireless nodes 322, 324 may each be coupled to a wireless node 320 via a wireless link. Wireless node 320 and other wireless nodes 308, 310 may each may be coupled to a wireless node 304 via a wireless link. Wireless node 304 may be, for example, a base station (BS), access point (AP) or other wireless node. Wireless node 304 may be coupled to a fixed network, such as network 306, for example. Frames or data flowing from nodes 332, 334 to 330, 322 324, and 330 to 320, and 308, 310, 320 to node 304 may be referred to as flowing in the uplink (UL) or upstream direction, whereas frames flowing from node 304 to nodes 308, 310, and to node 320 and then to nodes 330, 322, 324, 332, and 334 may be referred to as flowing in the downlink (DL) or downstream direction, for example.

The various embodiments described herein may be applicable to a wide variety of networks and technologies, such as WLAN networks (e.g., IEEE 802.11 type networks), cellular networks, IEEE 802.16 type networks, radio networks, long term evolution (LTE) of 3GPP networks, 4G systems, WiMax, WINNER, or other wireless networks. In another example embodiment, the various examples and embodiments may be applied to a meshed wireless network, where a plurality of mesh points (e.g., Access Points) may be coupled together via wired or wireless links. The term “node” or “wireless node” or “network node” or “network station” may refer, for example, to a wireless station, e.g., a subscriber station or mobile station, an access point or base station, a relay station or other intermediate wireless node, or other wireless computing devices, such as laptop computers, desktop computers, and peripheral devices, as examples.

When using OFDMA it may be possible to configure the coding and modulation differently for different subcarriers and schedule transmissions such that subcarriers that experience an unacceptable amount of interference may be avoided. The interference avoidance techniques discussed herein may exploit these capabilities by communicating indications of subcarriers on which interference occurs and setting different allowed power levels to subcarriers to limit the interference.

Furthermore, spreading codes may be added spreading the information (e.g., user data) over multiple subcarriers according to specific codes resulting in MC-CDMA. Further, coding may be applied over the different subcarriers resulting in Coded OFDM. One skilled in the art of communications will appreciate that there are many possible variations of the radio access scheme.

An example WINNER system may be a very flexible system and may facilitate various types of traffic, various mobility models, etc. Therefore users and/or flows may be treated differently. The following parameters may be used to distinguish between the users and/or flows: 1) frequency adaptive/non-adaptive users/flows, 2) QoS level of flow, or 3) required power level of users/flows.

In the example WINNER system it may be assumed that users are grouped into frequency adaptive and frequency non-adaptive users. Frequency adaptive users may thus gain from frequency domain scheduling. In order to facilitate frequency adaptive scheduling the users may feedback their current signal-to-interference-and-noise ratio (SINR) of the subchannels to the radio access point. Frequency adaptive users may have a frequency selective channel, low mobility and a medium to large amount of data traffic. RN-RN and BS-RN communication may be considered as frequency adaptive traffic as well, e.g., for nonline-of-sight (NLOS) connection. Frequency non-adaptive users may not benefit from frequency domain scheduling because the channel may not be frequency selective or may change too fast and the feedback is inaccurate or the amount of feedback data may be prohibitive.

Users of an example WINNER system may use very diverse applications, e.g., voice calls, interactive gaming, or downloading of large files in the background. Therefore, different Quality of Service (QoS) levels may be specified for the example system. The different QoS levels may be considered in the example radio resource management schemes discussed herein.

Example transmit power levels for reliable communication between a radio access point (RAP) and mobile stations (MS) may depend on many parameters, for example, on the path loss, the modulation and coding scheme in use, the status of any interference activity, the receiver capabilities, the required data rate, etc. Thus, MS and flows may be grouped depending on the required power levels, for example, Max power/max power −3 dB/max power −6 dB/max power −9 dB/max power −12 dB. The different power levels may be determined by an example soft-frequency reuse inter-cell interference management technique.

The amount of measurements available at the serving relay node and base station may differ depending on the user and flow. For example, all users may measure the average SINR that they experience and may report the dominant interferers or interfering nodes and their relative signal strength compared to the serving relay node or base station. Further, the current PER may be available at the serving relay node or base station. Frequency adaptive users, for example, may measure and feed back accurate SINR for the subchannels relevant to them.

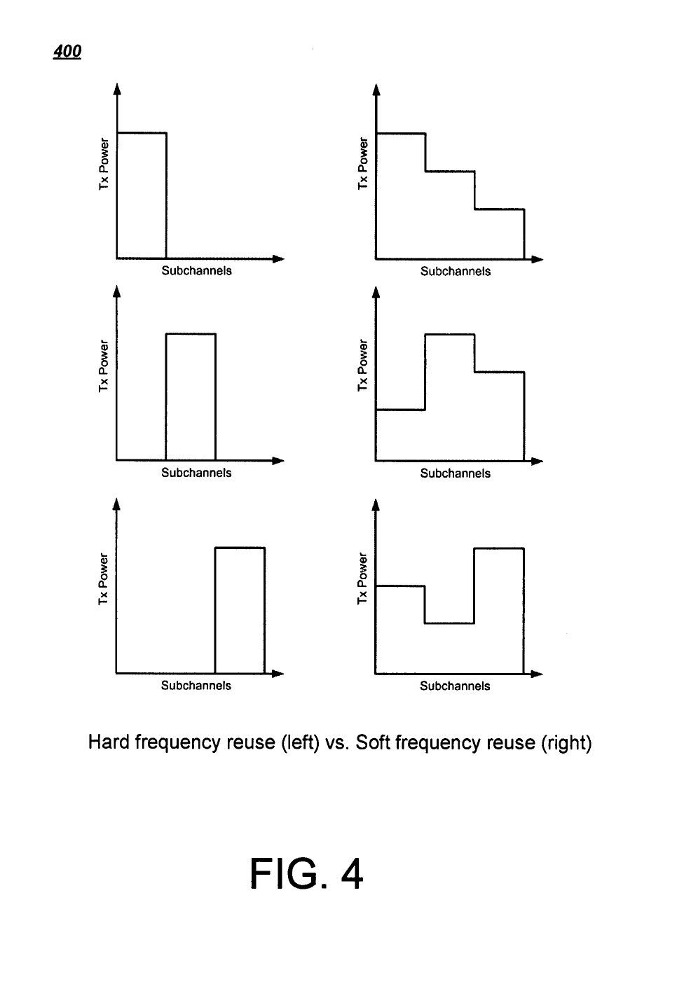

Instead of hard frequency reuse, soft-frequency reuse may be provided in an example radio resource management technique of the WINNER system. Soft frequency reuse has been proposed also, for example, for the 3GPP LTE system. FIG. 4 illustrates an example difference between hard and soft frequency reuse. For example, hard frequency reuse, as shown in the left-hand column of FIG. 4, may improve the SINR for users at the edge of a cell. However, a RN or BS may still communicate with proximately close users using lower transmit power, and thus the interference may be tolerable for the users at the edge of the cell. The number of different power levels may be varied. An example of different power levels may include max power/max power −3 dB/max power −6 dB/max power −9 dB.

Instead of using soft frequency reuse, as shown in the right-hand column of FIG. 4, the spectrum may be divided into exclusive, shared and prohibited subchannels according to the following: 1) exclusive subchannels P=max; 2) prohibited subchannels P=0; and 3) shared subchannels P=max and also less is possible. Further, the spectrum mask may be varied in time, for example, to maximize frequency diversity for each group of users.

Scheduling may be used as a means to mitigate the interference between different Radio Access Points (RAPs). The different types of transmission may have different characteristics while being transmitted. Frequency adaptive transmissions may originate from high performance users with a stable high bit rate and low mobility speed. Thus, these users may create interference in a predictable manner. However, frequency non-adaptive users may include highly mobile users that incidentally transmit data, resulting in a much less predictable interference pattern. Further, contention based channel access may result in very random arrival of data, and thus interference.

Scheduling may easily be performed in the downlink from a RAP since the RAP has complete knowledge about the traffic types. In uplink, scheduling may be applied as well, but a polling mechanism of the users that are allowed to transmit data may be needed. Thus, the users may be scheduled such that an interference pattern may be generated that ensures predictability of that interference.

In order to ensure this predictability the users may be scheduled within a super-frame in a predictable manner. For example, the frequency adaptive users may be scheduled first, then the frequency non-adaptive users. The remaining part of the super-frame may be used for contention based channels. An Allocation Table for the next superframe may be transmitted, for example, in the last DL slot.

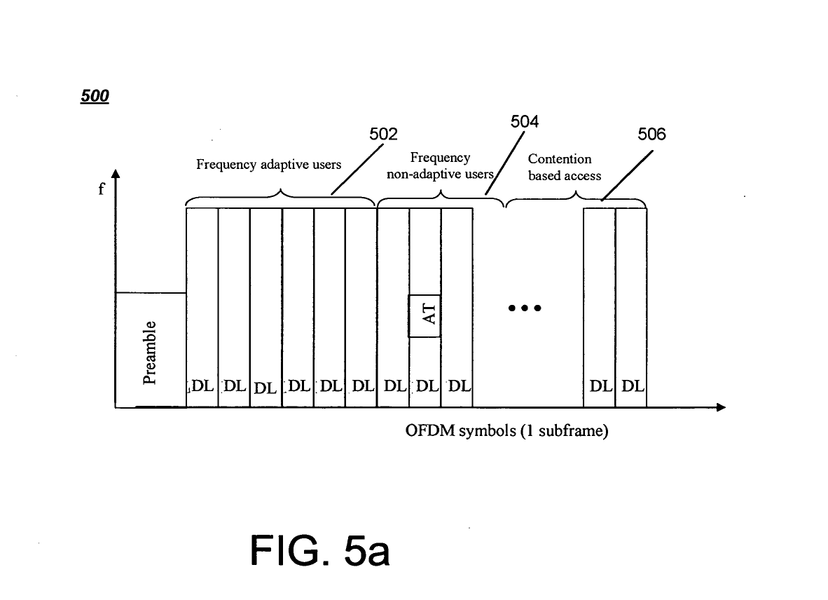

The scheduling may be done over different physical parameters, for example, over time or in frequency, but also over the power profile. An example frame structure that may be used in a WINNER system is illustrated in FIGS. 5a and 5b.

Users may be scheduled within a frame according to many example techniques. For example, as shown in FIGS. 5a and 5b, the first OFDM symbols 502 within the frame may be allocated preferably to the frequency adaptive users, to ensure utilization of channel state information (CSI) that is as recent as possible. In the following OFDM symbols 504 the frequency non-adaptive users may be scheduled and the unused parts of the OFDM symbols 506 may be used for contention based access. As shown in FIGS. 5a and 5b, “AT” may denote the allocation table that is signaled for the next frame.

In order to implement this example scheduling scheme the scheduler may need to obtain knowledge about the frequency-adaptive transmissions. First, the frequency adaptive users may be identified, for example, from a coherence time measurement, or from a control message indicating that f-adaptive transmission is possible. MS in f-adaptive mode may report regularly detailed CSI, i.e., SINR for the subchannels in use, which may include a subset of the available subchannels.

Each RAP may have, for example, an assigned spectrum mask within which it may freely schedule its associated nodes. The assigned spectrum mask of a RN may be changed by signaling from the BS.

Example relay based networks may include a large number of nodes, and thus, reducing the control overhead for radio resource management may be desirable. Centralized radio resource management (RRM) schemes may be challenged by distributed RRM schemes, because of the large amount of signaling involved (e.g., measurements, radio resource allocation) and their complexity. Especially in relay based systems, where the signaling may be done through multiple hops the signaling load may become more critical and the delay with which measurements arrive may increase.

However, a distributed RRM scheme that requires extensive signaling of relay nodes (RNs) to communicate to RNs of other cells may not be desirable because of high signaling delays and possibly large signaling overhead. Therefore, distributed RRM schemes that do not require extensive signaling may be desirable.

An example RRM scheme may include the use of soft frequency reuse (i.e., power masks in frequency or time for each radio access point (RAP)). By using power masks, frequency reuse 1 may be achieved and the signal-to-interference-and-noise ratio (SINR) of users at the cell border may be improved. However, simply assigning a fixed power mask to each relay enhanced cell (REC), which is then divided between the base station (BS) and the different RNs may be inflexible and may leave a very small amount of resources for each individual radio access point (RAP). Thus, such a static assignment may not be desirable and an adaptive solution may perform better.

Example techniques discussed herein include an intra-cell interference coordination scheme for relay enhanced cells. The interference coordination scheme may be based on interference measurements taking place at the mobile terminals (MTs) and at the relay nodes (RNs) in the network. If one or more of the interference measurements may be considered unacceptable (e.g., above or below a predetermined threshold), the node(s) causing the unacceptable interference activity may be referred to as disturbing interferers or disturbing interfering nodes. The MTs and the RNs may report identifiers (IDs) of disturbing interferers or interfering nodes to their serving radio access point (RAP), which may be the BS or a RN. The RNs serving other RNs or MTs may then forward the IDs of the disturbing interferers or interfering nodes to the BS. Based on these reports the base station may adjust the resource allocations to the different relay nodes. For example, the BS may assign different power masks to the RNs in its cell. The BS may assign the power masks based on the intra-cell interference situation and the traffic load of the different nodes in the cell. Thus, the BS may balance the local interference situation, traffic load and Quality-of-Service (QoS) requirements. The example techniques discussed herein include example measurements and signals for the example scenarios.

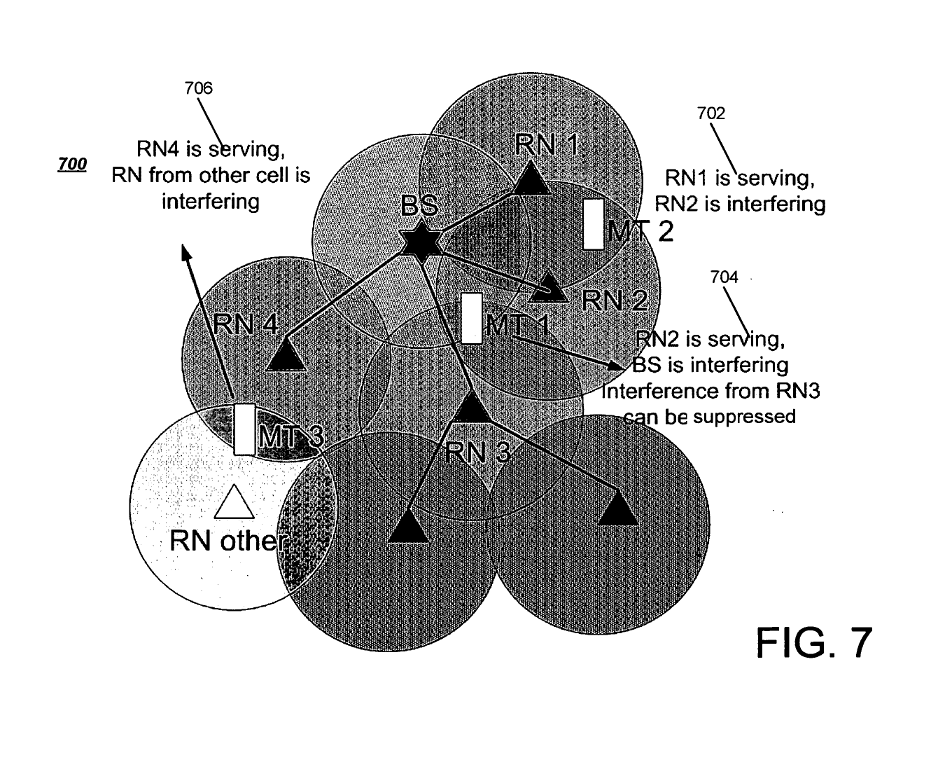

According to an example embodiment, a power mask may indicate a transmission power level for a network entity or node, such as a transmission power level for one or more channels or time slots. Thus, the power masks for each entity, for example, as shown in FIG. 8, plot power (Y axis) versus frequency/time (X-axis). Frequency/time are shown in the X axis since the assigned transmission power may be assigned for a specific frequency (frequency band) or channel, or a specific time slot, or a combination, as examples. According to an example embodiment, an example power mask may assign or indicate power levels associated with one or more of a channel, a time slot, a subchannel, or a subcarrier. The power masks may allow for soft frequency reuse, by providing different transmission powers for entities or nodes having overlapping coverage, for example.

Resource Scheduling (e.g., actual chunks on the radio link) may be handled locally by the relay nodes. The interference coordination scheme may, for example, be integrated in a radio resource management (RRM) framework for a relay based 4th generation wireless communication system.

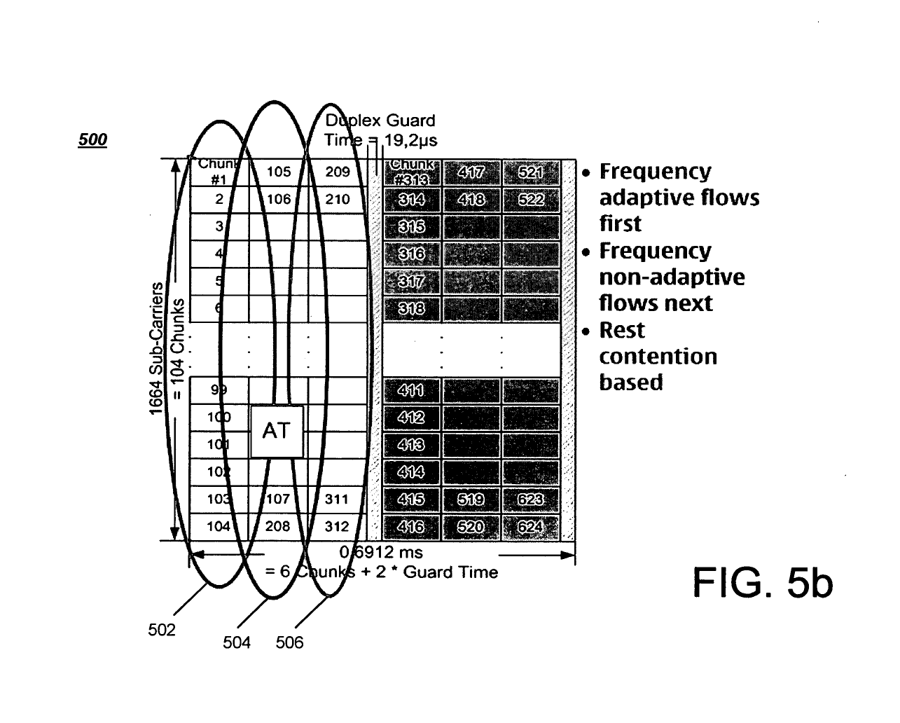

FIG. 6 illustrates an example scenario 600 in which the relay nodes may have power and coverage area similar to that of the BS. Further, the example scenario is not restricted to two hops (BS-RN-UT), but may include 3 (BS-RN-RN-UT) or more hops. This scenario may include many RNs with different coverage areas. Thus, any fixed frequency reuse between cells, wherein the resources in the cell are divided between the BS and the RNs may not make efficient use of the available radio resources. Even soft-frequency reuse with a single power mask for the whole cell, wherein the high power resources are then split between the RNs, may not make efficient use of the available radio resources.

The example techniques discussed herein may be beneficial in example scenarios wherein a single RN serves only a few MTs. Such example scenarios may include a cell in a city center with a BS and additionally many low cost relays in the cell. In such a scenario the coverage area of a single RN may be limited and the RN may serve only a few active MTs at a time. Adapting the resources available for the BS and RNs in such a cell based on the local interference situation and the traffic load may make more efficient use of the available resources.

According to an example embodiment, the BS may assign a power mask for the RNs in its relay-enhanced cell (REC) based on the following:
1) the power masks may be assigned according to the traffic load of the radio access points (RAPs)
2) information about the interference that the radio access points (RAPs) in the REC generate with respect to each other may be utilized. The interference information is gathered from measurement reports
3) adaptation of the power mask may be triggered by reports of disturbing interferers or interfering nodes and changing traffic loads
4) update of the power mask may be occurring on a slower timescale than the resource scheduling (e.g., at most every 200-500 ms)

Further, the BS may, for example, consider constraints for the power mask coming from spectrum sharing or inter-cell interference coordination.

The MTs (e.g., in active state) and the RNs may report the disturbing interferers or interfering nodes in downlink, i.e., interferers or interfering nodes that may be suppressed by interference rejection combining (IRC) or that may be cancelled may not be not reported.

Thus, the example techniques may be discussed with regard to MTs performing the measurements and the reporting. Similarly, as RNs may be receivers in downlink, the example techniques may be used by relay nodes as well. Due to low mobility of an MT, the disturbing interferers or interfering nodes may remain the same for an extensive period of time and the MT may then report only changes in the interfering activity, which may be preferable to regular reporting.

According to an example embodiment, an MT may identify disturbing interferers or interfering nodes and report their IDs in a message to the MT's serving RAP. If the serving RAP is a RN, then it forwards the message to the BS of the relay enhanced cell. It is noted that the measurement and the signaling load may be reduced significantly if a significant number of the MTs are static.

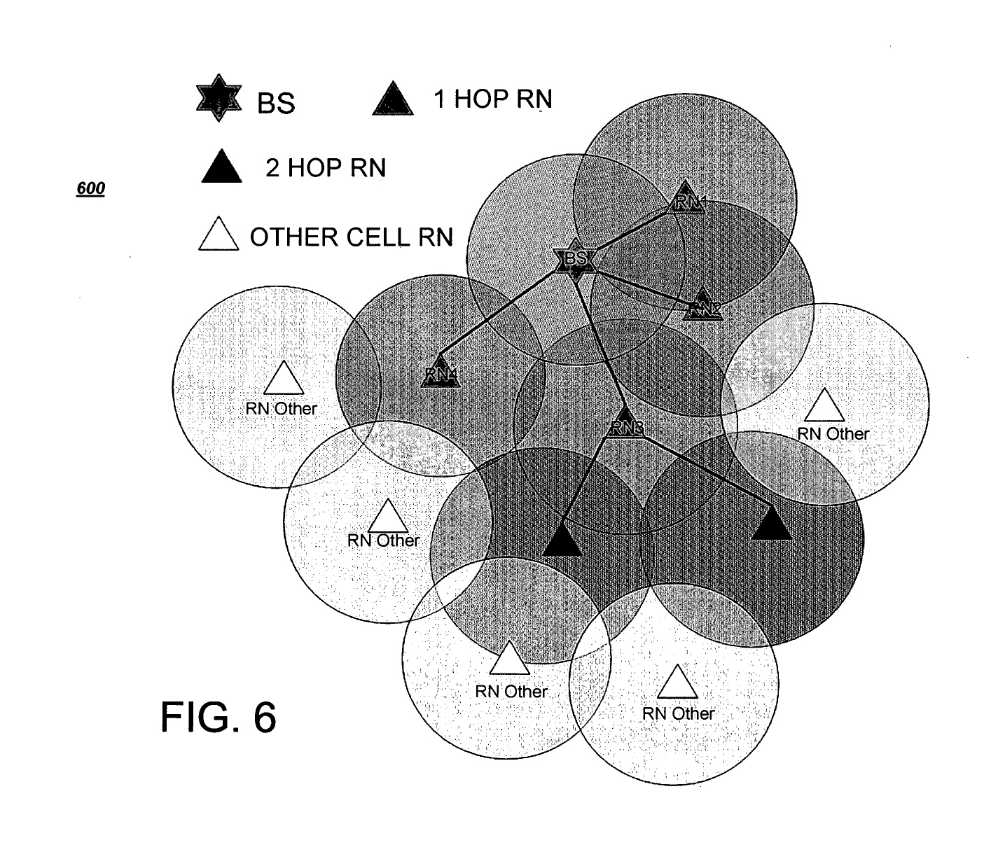

FIG. 7 illustrates an example wireless network including three possible example interference scenarios 702, 704, 706. In the first example scenario 702, RN1 is the serving RAP for MT2 and MT2 reports RN2 as an interferer or interfering node. In the second example scenario 704, MT1 is served by RN2 and receives disturbing interference from the BS, but can suppress the interference from RN3. Therefore it only reports the BS as an interferer or interfering node. In the third example scenario 706, MT 3 is served by RN4 and receives interference from the RN of another cell. In the scenario 706, MT3 may report the interference but the interference as described is not intra-cell interference.

If the disturbing interferer or interfering node is within the relay-enhanced cell (REC), the BS may adapt the power mask of the disturbing interferer or interfering node (e.g., RN or BS) accordingly, i.e., the BS may assign low power resources to the disturbing interferer or interfering node. Further, the BS may signal to the serving RN that it can schedule a particular MT with reduced interference from the disturbing interferer or interfering node in particular resources.

FIG. 8 illustrates an example original power 802 and updated power 804 mask. In the example as shown, RAP 1 is causing interference to a MT served by RAP 2 and the BS is updating the power mask. The BS thus assigns low power resources 806 to RAP 1 and thereby reduces the interference that RAP 1 may cause to RAP 2.

Decisions regarding whether to adapt a power mask and/or how to adapt a power mask may, for example, be based on the following:
1) Amount and type of traffic the MT reporting the interferer or interfering node may be using (i.e., amount of resources needed)
2) If there is very little downlink (DL) traffic through the disturbing interferer or interfering node, then the power mask may not be updated to reduce signaling load
3) If the disturbing interferer or interfering node has no free resources (e.g., the BS can estimate the amount of free resources of every RAP in the cell) then the BS may, for example, use one or more of the following:
   a) if the flow(s) to this MT has high priority the power mask is updated,
   b) if the flow(s) to this MT has low priority the power mask is not updated
   c) if the disturbing interferer or interfering node is fully loaded but it also serves low priority flows, then the power mask is updated
4) More advanced policies may be used to further refine fairness and QoS offerings. The strategies/policies used by these example techniques may involve a delicate balance between resource allocation and scheduling. Until an interference limited regime is reached the problem may involve a resource allocation problem. After this, for example, scheduling and priority of certain flows may also become important considerations.

If the disturbing interferer or interfering node is not within the REC, then mechanisms for inter-cell interference coordination may be used.

An interference situation of a terminal may change significantly depending on which spatial mode is used by the interfering RAP. For example, one spatial mode may cause disturbing interference and other mode(s) may not. Therefore, the ID of the disturbing interferer or interfering node may not be sufficient and thus, for example, the spatial mode may be additionally considered to increase the spectral efficiency.

If a fixed grid of beam is used at the disturbing interferer or interfering node, the MT may be able to distinguish between the beams and may report its ID plus the disturbing beam(s). If all of them are disturbing, then no beam need be mentioned in the message.

If user specific beamforming or other spatial modes without fixed patterns are used then only the interfering RAP may know the spatial transmission mode it was using. In this case the MT may be able to determine which RAP was transmitting at the time when it could not decode its own packet. The MT may thus add this timestamp and the sub-channels to the message regarding the disturbing interferer or interfering node that the MT sends to its serving RAP. Additionally to updating the power mask, the BS can then signal to the interfering RAP 1) that it cannot use the spatial mode it used at timestamp xx and for sub-channel(s) yy for the specified part of the power mask and/or 2) that it has to reduce the power for the spatial mode, it used at timestamp xx and for sub-channel(s) yy for the specified part of the power mask.

Thus, the interfering RAP may be allowed to use other spatial modes, for example, if user specific beamforming is used, the interfering RAP may still transmit to other users.

As intra-cell interference coordination may, in some cases, not be as significant in uplink (UL) as in downlink (DL), a very simple scheme may provide acceptable results. The BS and the RNs may identify the potentially disturbing interferer or interfering node. The RN or BS may attempt to schedule its served MT and may avoid sub-channels with disturbing interferers or interfering nodes, i.e., the signal from the served MT cannot be decoded even with interference rejection combining (IRC) or interference cancellation.

If there are not sufficient resources available for an RN or BS recipient of interference, the RN or BS recipient may, for example, report the IDs of the disturbing interferers or interfering nodes and the BS may assign a power mask that assigns high power resources to the RAP interference recipient and low power resources to the interfering RAP.

As the traffic load in uplink and downlink may vary significantly, the BS may assign different power masks for uplink and downlink.

Even though the example techniques discussed herein may be presented in the context of a WINNER system, the example techniques may also be applicable to other relay based radio systems as well (e.g., WiMAX).

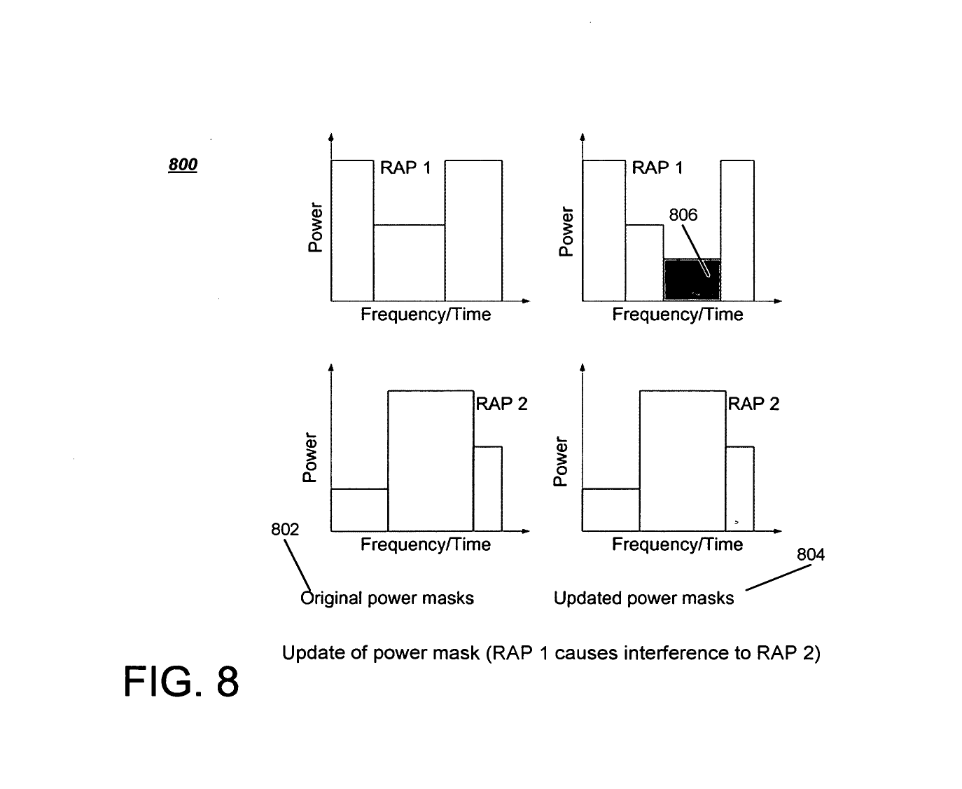

As illustrated in FIG. 9, the MTs may measure interference and may report the interference measurements to their serving radio access point (e.g., BS or RN). The RNs may collect the measurements from the MTs, and may append more information (e.g., an ID of the terminal), add their own measurement or interference report, and forward the measurement or interference reports to the BS.

The measurement or interference report may, for example, include one or more of: 1) an ID of the interfering node; 2) a subchannel on which the interfering node was detected; 3) a timestamp, indicating when the interfering node was detected; 4) an ID of a beam, if the interfering node uses a grid of beams; 5) an ID of the MT or RN that is sending the measurement report; 6) a location of the MT or RN, etc.

According to an example embodiment, a minimum configuration may include at least the IDs of interfering nodes in the measurement report.

According to an example embodiment, the measurement or interference report may be reduced by, for example, using conventional compression techniques.

In order to detect interfering nodes, it may be desirable, for example, to determine an example threshold such that nodes that may be considered as disturbing interferers or interfering nodes have a signal strength that is larger than the threshold (e.g., the threshold may be pre-defined, a system parameter, or adaptive). Thus, the disturbing interferers or interfering nodes may be referred to as causing an interference activity, which may be determined to be an unacceptable interference activity if certain conditions are met, for example, having a signal strength that exceeds the threshold, as discussed above. According to an example embodiment, an example of such a threshold may be xdB below the signal strength of the serving RAP. Thus, if the interferers' signal strength is greater than or less than xdB below the signal strength of the serving RAP, then it may be classified as a disturbing interferer or a disturbing interfering node (i.e., the disturbing interferer or disturbing interfering node is causing an unacceptable interference activity). For an example OFDMA system, one threshold may be used for the whole received signal, or the threshold may, for example, be applied to each sub-channel.

According to an example embodiment, interference from interfering nodes that may be suppressed by advanced signal processing techniques, for example, by interference rejection combining (IRC), interference cancellation, may not be reported.

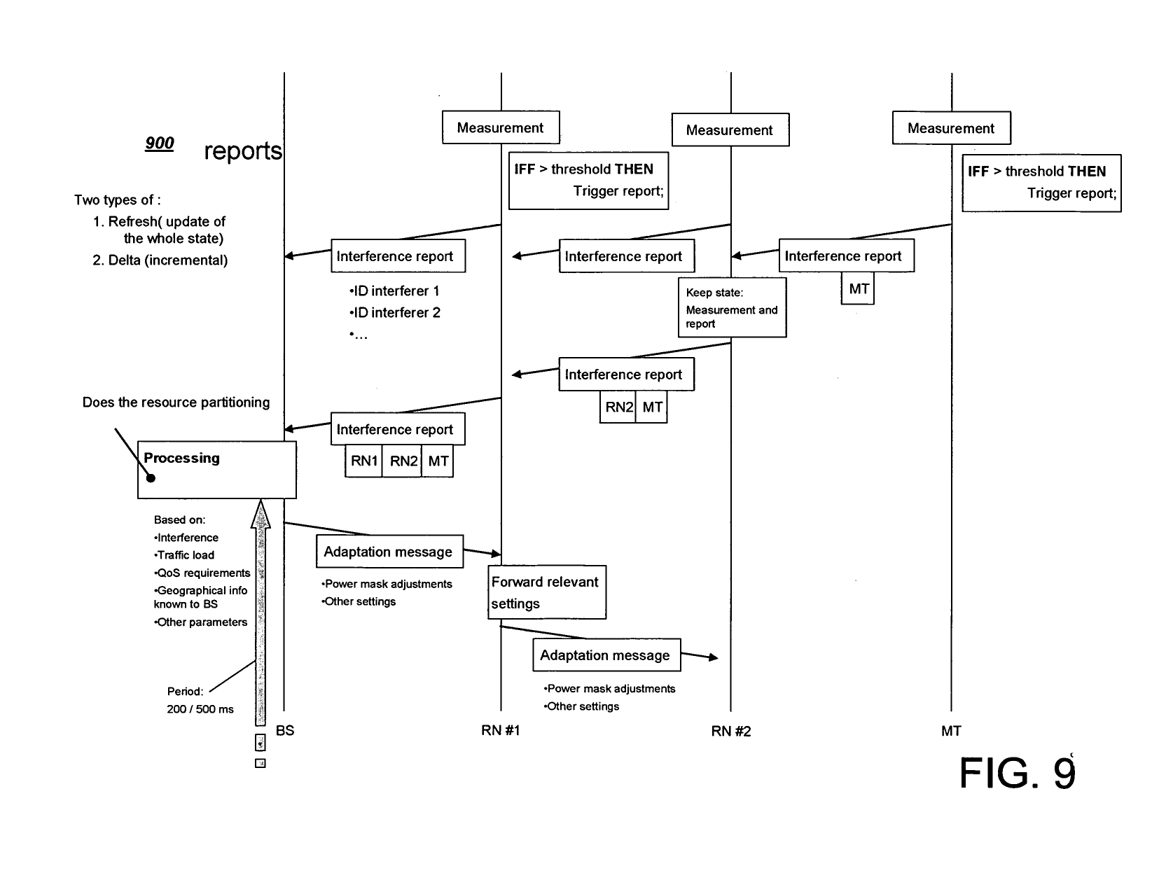

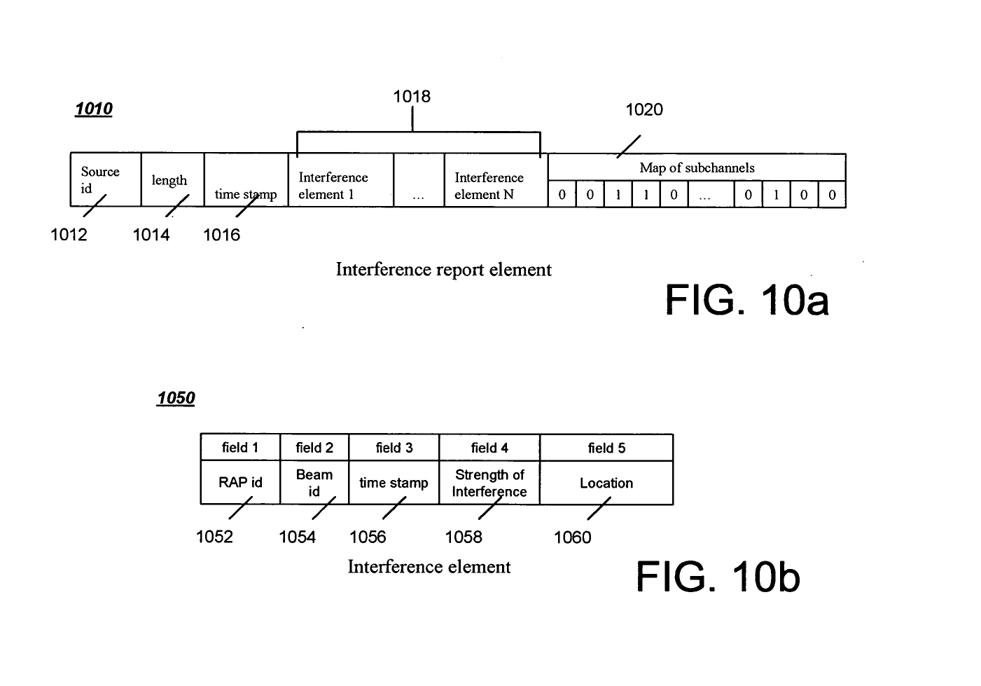

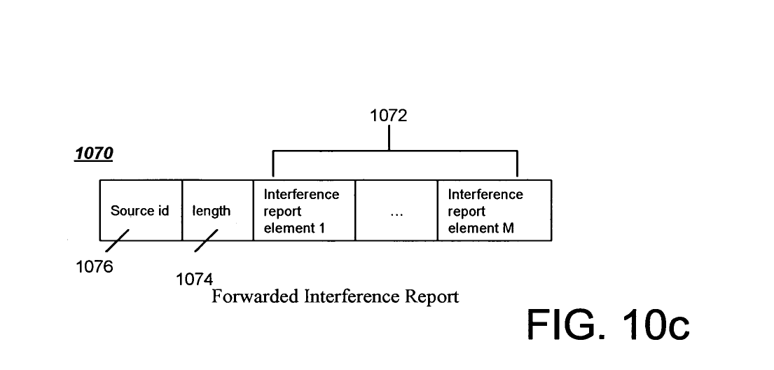

When interference is detected, a node in the wireless network may generate an interference report element 1010, for example, as shown in FIG. 10a, that may include a source id 1012, a length 1014 (which may vary depending, for example, on the options included in the message), a time stamp 1016, several interference elements 1018 describing the interference of particular interfering nodes, and, for example, an optional field 1020 that may indicate availability of subchannels via an example binary mapping. In the example mapping a 1 may indicate an unacceptably high level of interference and a 0 may mean that a subchannel is available. This example mapping may be compressed or coded to optimize the message.

As shown in FIG. 10b, according to an example embodiment, an example interference element 1050 may be used to report the interference perceived from another Radio Access Point (base station or relay) 1052. If variable antenna beams are used, for example, a beam id 1054 may be transmitted. Further, a time stamp 1056 may be included. The strength of the interference 1058 (e.g., the strength of the interfering node may be indicated using the “Signal Strength Serving RAP”/“Ratio Signal Strength Interferer,” Carrier-to-Interference Ratio) and location information for the device 1060 may be included.

According to an example embodiment, the interference report elements 1010 may be transmitted as interference reports, for example, as shown in FIG. 10c. When the messages are forwarded they may be concatenated into a forwarded interference report 1070 including multiple interference reports 1072, and an indication of the length 1074 as well as a source address 1076.

According to an example embodiment, to optimize the number of bits transmitted the source ID may not have to be present in the first interference report element since this is the same as the source ID of the forwarded interference report. However, when forwarding an interference report, relay nodes may ensure that the proper source addresses are included again.

One example measure of the strength of an Interferer or interfering node may include a “Signal Strength Serving RAP”/“Ratio Signal Strength Interferer,” Carrier-to-Interference Ratio.

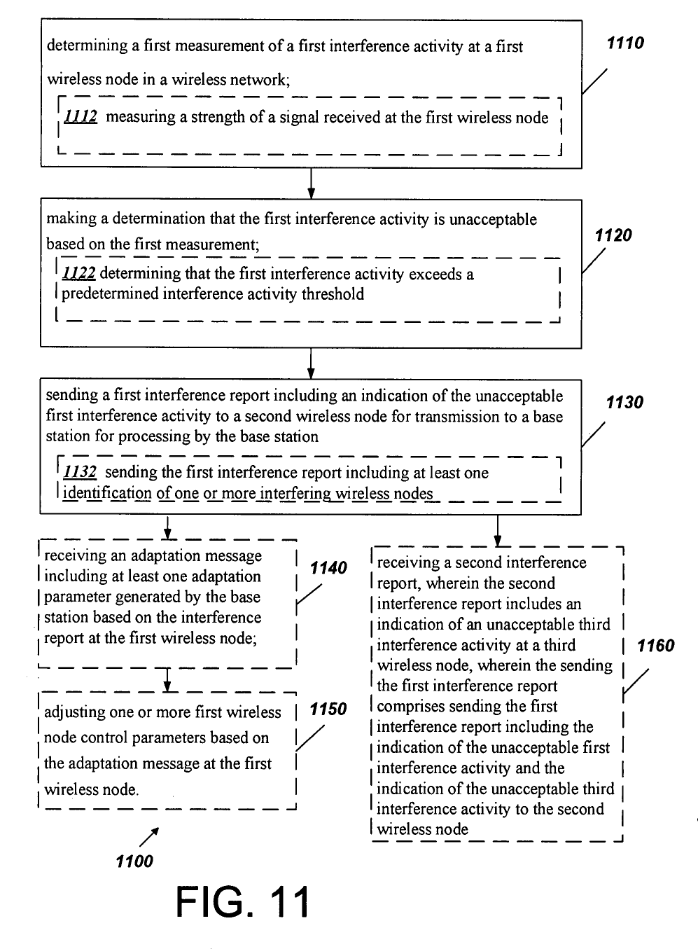

FIG. 11 is a flowchart illustrating operation of a wireless node according to an example embodiment. At 1110, a first measurement of a first interference activity may be determined at a first wireless node in a wireless network. According to an example embodiment, a strength of a signal received at the first wireless node may be measured (1112).

At 1120, a determination may be made that the first interference activity is unacceptable based on the first measurement. According to an example embodiment, the determining may include determining that the first interference activity exceeds a predetermined interference activity threshold (1122).

At 1130, a first interference report including an indication of the unacceptable first interference activity may be sent to a second wireless node for transmission to a base station for processing by the base station. According to an example embodiment, the first interference report including at least one identification of one or more interfering wireless nodes may be sent (1132).

According to an example embodiment, an adaptation message including at least one adaptation parameter generated by the base station based on the interference report may be received at the first wireless node (1140). One or more first wireless node control parameters may be adjusted based on the adaptation message at the first wireless node (1150).

According to another example embodiment, a second interference report may be received, wherein the second interference report includes an indication of an unacceptable third interference activity at a third wireless node, wherein the sending the first interference report includes sending the first interference report including the indication of the unacceptable first interference activity and the indication of the unacceptable third interference activity to the second wireless node (1160).

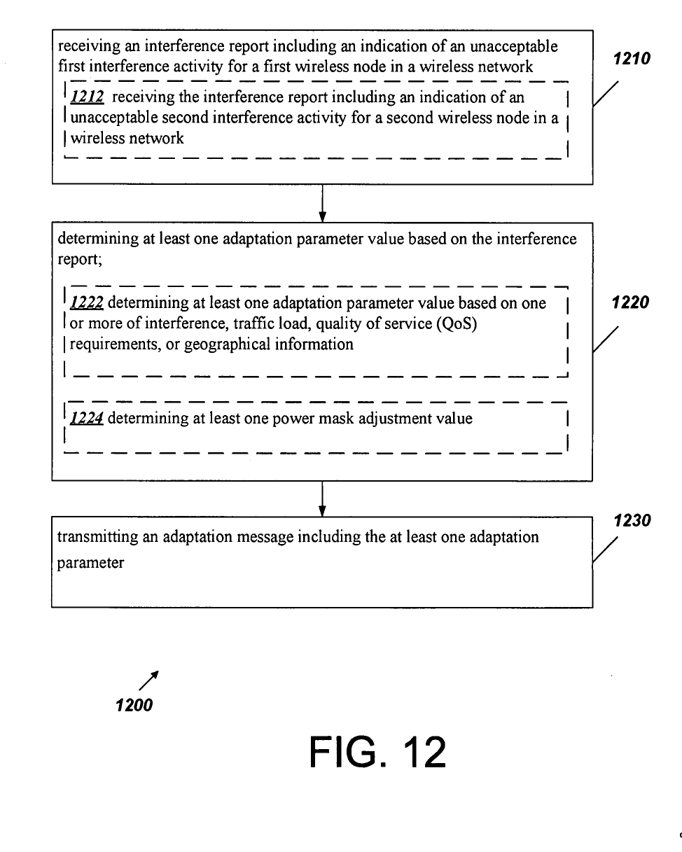

FIG. 12 is a flow chart illustrating operation of a wireless node according to an example embodiment. At 1210, an interference report including an indication of an unacceptable first interference activity for a first wireless node in a wireless network may be received. For example, the interference report may be received at a base station (BS). According to an example embodiment, the interference report including an indication of an unacceptable second interference activity for a second wireless node in a wireless network may be received (1212).

At 1220, at least one adaptation parameter value may be determined based on the interference report. According to an example embodiment, at least one adaptation parameter value may be determined based on one or more of interference, traffic load, quality of service (QoS) requirements, or geographical information (1222). According to an example embodiment, at least one power mask adjustment value may be determined (1224). At 1230, an adaptation message including the at least one adaptation parameter may be transmitted.

The example intra-cell interference management techniques discussed herein may involve less signaling and less complexity than centralized radio resource management (RRM) techniques. Further techniques discussed herein may be suitable for relay based communication systems and may use the knowledge available at the base station, i.e., traffic load and interference status of the nodes in the relay enhanced cell to reduce intra-cell interference and to make more efficient use of the available radio resources. Moreover, for example, the techniques may also be flexible enough to support spectrum sharing and flexible spectrum use methods.

In contrast, for inter-cell resource management schemes, resource requests may be sent every scheduling period, which may not be feasible for intra cell interference management. Moreover, relay nodes may be independent nodes and thus a certain delay may be involved with every communication. Additionally, relay networks may not be restricted to two hops, and therefore the delays may accumulate. Because of these delays, resource updates faster than every 200-500 ms may not be feasible. Next to the delays the resource partitioning should be done at most every 200-500 ms—otherwise the signaling load may not be feasible. Especially in multi-hop networks, the BS may not be able to control the scheduling of all the relay nodes, for example, due to a high signaling load, and thus at most it may be able to perform updates on the resource partitioning.

Regarding the example intra-cell interference techniques discussed herein, the IP traffic may be bursty. However, knowledge about the traffic may be exploited because 1) on a single packet level, nothing may be predicted; 2) the traffic level per relay and cell may be predicted (e.g., most of the sessions include a flow of packets—even web browsing, as the pages tend to become larger over time. Further, VoIP produces regular packets every 20 ms, FTP a stream of IP packets, etc. Because of that the amount of traffic in the next second(s) can be predicted and the knowledge can be exploited); and 3) especially in multi-hop systems the traffic of several relays may accumulate at relays close to the base station, and the accumulated traffic may be easier to predict.

For the intra-cell interference techniques, the interference may vary quickly. However, even without very fast signaling it is possible to exploit the knowledge about the interference in an urban environment, where a majority of the terminals may move slowly. In some deployment scenarios relays may reduce the coverage area of a single access point, the coverage may be much more fragmented, and there may be only a few users per cell. Further, in an urban environment, there may be a lot of shadowing from buildings. Moreover, a hexagonal cell layout scheme may not apply in such scenarios.

Additionally, an interference situation may vary significantly within the coverage area of a radio access point, and these variations should be taken into account (e.g., interferer or interfering node reporting).

More particularly for deployments below rooftops: street canyons may act as a wave guide and the signals may travel far in streets with line-of-sight (LOS). Thus these dominant interferer(s) may remain the same in large portions of a street.

Moreover, future wireless communication systems may be synchronized (e.g., the TDD systems) and frequency domain scheduling gains may be exploited for slow moving terminals. For example, frequency adaptive flows may be scheduled first, thus introducing regularity on the resources that may be scheduled by an access point and thus the interference from them may be predicted.

Resource partitioning that may be included in the example intra-cell interference management techniques discussed herein may be triggered by reported interferers or interfering nodes. However, knowing IDs of reported interferers or interfering nodes as such may not be sufficient. For intra-cell interference scenarios, the BS may know all the flows that are handled by relays within its relay enhanced cell. Thus, the BS may have information about the traffic load and QoS requirements of these flows. Therefore, the BS may use this information when it does the resource partitioning. Thus, resource requests that may result in a high signaling load may be avoided. It is noted that in a system without relays and with fast, high bandwidth inter-connections between base stations and radio network controllers, the resource requests may be handled and there is no need for anything further. The combined use of reported interferers or interfering nodes, traffic load and QoS requirements of the flows handled by the relays may provide an effective management technique.

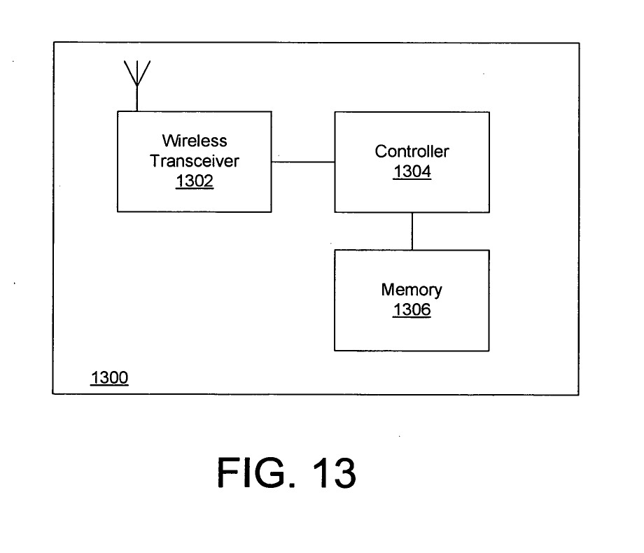

As shown in FIG. 13, each node (e.g., mobile station or AP) may comprise an apparatus 1300 according to an example embodiment. The apparatus 1300 may include, for example, a wireless transceiver 1302 to transmit and receive signals, a processor or controller 1304 to control operation of the node and execute instructions or software, and a memory 1306 to store data and/or instructions. Each node may be programmed or adapted to perform the various functions or tasks described above. The wireless node controller 1304 may be programmable, and capable of executing software or other instructions stored in memory or on other computer media to perform the various tasks and functions described above. In addition, a storage medium may be provided that includes stored instructions, when executed by a processor (such as a node or the node's processor 1304) will result in the processor performing one or more of the functions or tasks or services described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or computer readable medium or in a propagated signal, for execution by, or to control the operation of, a data processing apparatus, e.g., a programmable processor or multiple processors, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
determining a first measurement of a first interference activity at a first wireless node in a wireless network;
making a determination that the first interference activity is unacceptable based on the first measurement; and
sending a first interference report including an indication of the unacceptable first interference activity to a second wireless node for transmission to a base station for processing by the base station.

2. The method of claim 1 wherein the determining the first measurement comprises measuring a strength of a signal received at the first wireless node.

3. The method of claim 1 wherein the making the determination that the first interference activity is unacceptable comprises determining that the first interference activity exceeds a predetermined interference activity threshold.

4. The method of claim 1 wherein the sending the first interference report including an indication of the unacceptable first interference activity to a second wireless node comprises sending the first interference report including at least one identification of one or more interfering wireless nodes.

5. The method of claim 1 wherein the sending the first interference report comprises sending the first interference report including at least one identification of one or more interfering wireless nodes and a timestamp indicating a time of receipt of an interfering signal.

6. The method of claim 1 wherein the sending the first interference report comprises sending the first interference report including one or more of: 1) an identification (ID) of an interfering node; 2) a subchannel on which the interfering node was detected; 3) a timestamp, indicating a time when the interfering node was detected; 4) an ID of a beam, if the interfering node uses a grid of beams; 5) an ID of a mobile terminal (MT) or relay node (RN) that is sending the interference report; or 6) a location of the MT or RN.

7. The method of claim 1 wherein the first wireless node comprises a mobile terminal or a wireless relay node.

8. The method of claim 1 and further comprising:
receiving an adaptation message including at least one adaptation parameter generated by the base station based on the first interference report at the first wireless node; and
adjusting one or more first wireless node control parameters based on the adaptation message at the first wireless node.

9. The method of claim 8 wherein:
the receiving the adaptation message comprises receiving the adaptation message including at least one power mask adjustment value, and
the adjusting includes adjusting one or more power levels based on the at least one power mask adjustment value.

10. The method of claim 9 wherein the at least one power mask adjustment value indicates one or more adjustments of one or more power levels associated with one or more of a channel, a time slot, a subchannel, or a subcarrier.

11. The method of claim 1 and further comprising:
receiving a second interference report, wherein the second interference report includes an indication of an unacceptable third interference activity at a third wireless node,
wherein the sending the first interference report comprises sending the first interference report including the indication of the unacceptable first interference activity and the indication of the unacceptable third interference activity to the second wireless node.

12. The method of claim 1 wherein the first interference report is received at the second wireless node and a second interference report including the indication of the unacceptable first interference activity is sent to a base station.

13. A method comprising:
receiving an interference report including an indication of an unacceptable first interference activity for a first wireless node in a wireless network;
determining at least one adaptation parameter value based on the interference report; and
transmitting an adaptation message including the at least one adaptation parameter.

14. The method of claim 13 wherein the receiving the interference report comprises receiving the interference report including an indication of an unacceptable second interference activity for a second wireless node in a wireless network.

15. The method of claim 13 wherein the receiving the interference report comprises receiving the interference report including a timestamp indicating a time of receipt of an interfering signal.

16. The method of claim 13 wherein the determining the at least one adaptation parameter value comprises determining at least one adaptation parameter value based on one or more of interference, traffic load, quality of service (QoS) requirements, or geographical information.

17. The method of claim 13 wherein the determining the at least one adaptation parameter value comprises determining at least one power mask adjustment value.

18. The method of claim 17 wherein the at least one power mask adjustment value indicates one or more adjustments of one or more power levels associated with one or more of a channel, a time slot, a subchannel, or a subcarrier.

19. The method of claim 13 wherein the determining the at least one adaptation parameter value comprises determining a power mask that assigns high power resources to a recipient of the unacceptable first interference activity and low power resources to an interfering node causing the unacceptable first interference activity.

20. The method of claim 13 wherein the determining the at least one adaptation parameter value comprises determining at least one adaptation parameter value based on one or more of reported interfering nodes, traffic load, or QoS requirements of flows handled by relay nodes.

21. An apparatus for wireless communications, the apparatus comprising:
a controller;
a memory coupled to the controller; and
a wireless transceiver coupled to the controller;
the apparatus adapted to:
determine a first measurement of a first interference activity at the apparatus;
make a determination that the first interference activity is unacceptable based on the first measurement; and
send a first interference report including an indication of the unacceptable first interference activity to another apparatus for transmission to a base station for processing by the base station.

22. An apparatus for wireless communications, the apparatus comprising:
a controller;
a memory coupled to the controller; and
a wireless transceiver coupled to the controller;
the apparatus adapted to:
receive an interference report including an indication of an unacceptable first interference activity for a first wireless node;
determine at least one adaptation parameter value based on the interference report; and
transmit an adaptation message including the at least one adaptation parameter.
